(19) United States
(12) Patent Application Publication
(10) Pub. No.: US 2007/0028783 A1
(43) Pub. Date: Feb. 8, 2007

(54) Brewing apparatus for preparing foam, froth, or crema under low pressure

(76) Inventors: Yee Mau Chen, Hong Kong (HK); Raymond Wai Ming Wong, Hong Kong (HK)

Correspondence Address: LAW OFFICES OF ALBERT WAI-KIT CHAN, LLC, WORLD PLAZA, SUITE 604, 141-07 20TH AVENUE, WHITESTONE, NY, 11357, US

(21) Appl. No.: 11/195,843

(22) Filed: Aug. 2, 2005

(51) Int. Cl. A23N 1/00

(52) U.S. Cl. 99/513

(57) ABSTRACT

The present invention pertains to a brewing filter apparatus capable of preparing foam, froth, or crema, particularly for coffee beverages, under low pressure. The apparatus can operate at pressures below 15 bar and as low as 1-3 bar. The apparatus comprises a filter, coffee container, O-ring, and foam maker having two opposing holes. The holes have a diameter in the range of 0.3 to 1 mm. The crema is created by the turbulent contacting of two opposing jets of coffee. To further increase agitation and the surface area for contact, a stainless steel wire mesh may be situated in the center of the foam maker directly in the path of and between the opposing jets of coffee to facilitate the formation of more crema.

### BACKGROUND OF THE INVENTION

Coffee beverages with a thick, foamy layer called “crema” are becoming increasingly popular among coffee drinkers and aficionados. Resembling the head one would find of a glass of stout, it is full of rich aroma and leaves a lingering flavor. Typically, coffee beverages, such as espresso, which are brewed under high pressure (15-19 bar) will have a layer of crema. The crema traps the fine aromatics and the light gaseous flavors of the coffee which can be quite pleasing to the palate. Like a blanket, it retains the pleasant aromas and flavors which would otherwise quickly escape from the coffee beverage.

Those of ordinary skill in the art currently use high-pressure brewing methods and apparatuses to prepare coffee beverages with the desired layer of foam, froth, or crema. It is widely-accepted by those in the art that good bar pressure is essential for making good crema. A pressure of 15-19 bar is considered the optimum range, although some skilled in the art claim 9-11 bar is sufficient if the coffee beans have been ground correctly. Unfortunately, it thus follows that regular coffee, which is currently brewed by conventional methods and apparatuses without high pressure, lacks the desired layer of crema. In response to this unmet need for a low-pressure solution, Applicants hereby disclose the present invention which relates to a brewing apparatus capable of preparing foam, froth, or crema, particularly for coffee beverages, using low pressures.

### SUMMARY OF THE INVENTION

The present invention pertains to a brewing filter apparatus capable of preparing foam, froth, or crema, particularly for coffee beverages, under low pressure. The apparatus of the present invention can operate at pressures below 15 bar and as low as 1-3 bar.

The apparatus of the present invention comprises a filter, a coffee container, an O-ring, and a foam maker having a plurality of holes. In a preferred embodiment, the filter is made of stainless steel, and the O-ring is made of silicone rubber. The apparatus is designed to be used in conjunction with a general brew head assembly, such as a single-serve coffee machine.

In a preferred embodiment, the foam maker comprises two small holes which directly oppose each other and have a diameter in the range of 0.3 to 1 mm, such that when coffee is being brewed, two small opposing jets of coffee liquid will race inward and turbulently contact each other inside the foam maker. To further facilitate the formation of crema, a stainless steel wire mesh may be placed inside the foam maker between the two jets of coffee liquid to increase the contact area and agitation. As a result of the agitation and turbulence, the contacted coffee liquid forms a layer of fine bubbles known as crema.

### DESCRIPTION OF THE FIGURES

The present invention relates to a low-pressure brewing apparatus capable of preparing foam, froth, or crema, especially for crema coffee. The present invention is shown in FIGS. 1 to 3.

FIG. 1 is a cross-sectional illustration of the brewing filter apparatus with arrows 1 showing the direction of the coffee flow/jet into the apparatus when preparing crema. In addition, a stainless steel wire mesh 2 is situated in the center between the coffee jets.

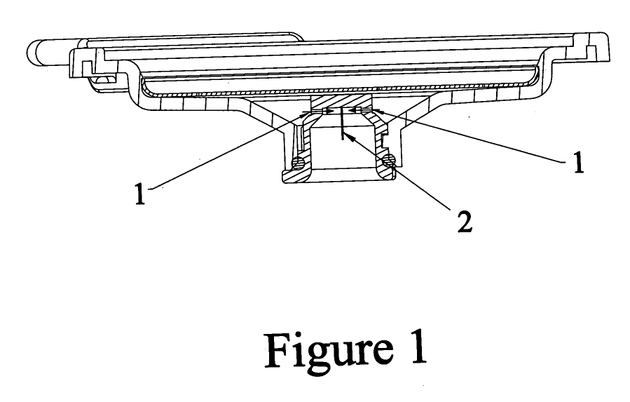

FIG. 2 is an exploded view of the brewing filter apparatus.

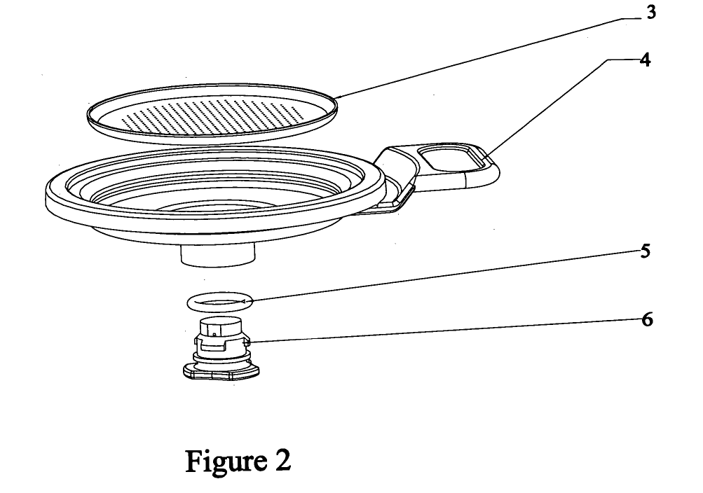

FIG. 3 is an isometric view of the foam maker showing one of the two opposing holes 7 for the coffee jets and a stainless steel wire mesh 2 situated in the center, separating the two opposing holes.

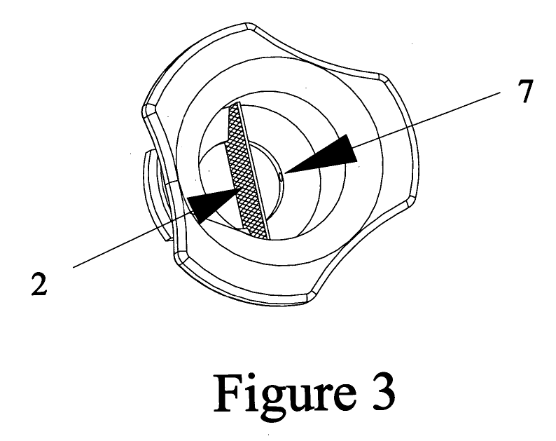

### DETAILED DESCRIPTION OF THE INVENTION

The present invention pertains to a brewing filter apparatus capable of preparing foam, froth, or crema, particularly for coffee beverages, under low pressure. While the current state of the art considers 15-19 bar pressure to be the optimum range for the formation of crema, the present invention is capable of preparing crema at pressures below 15 bar and as low as 1-3 bar.

The apparatus of the present invention comprises a filter 3, coffee container 4, an O-ring 5, and a foam maker 6 having a plurality of holes. In a preferred embodiment, the filter is made of metal, such as stainless steel, and the O-ring is made of silicone rubber. These parts may be assembled together after individual molding or other appropriate method of construction. The brewing filter apparatus is designed to be used in conjunction with a coffee or beverage-making machine.

The metal filter 3 is affixed to coffee container 4 from above and may be press-fitted or attached to the coffee container 4 using appropriate fitting methods, such as welding or brazing. The metal filter 3 is used to separate the coffee grounds or coffee pod from the foam maker 6. The foam maker is responsible for facilitating the formation of crema.

The main component of the brewing filter apparatus is the coffee container 4. The coffee container 4 of the brewing filter apparatus is designed to be used in obtaining and/or measuring the required amount of coffee grounds or coffee pods needed for making the desired amount of brewed coffee. The coffee container may be constructed of a suitable material that is FDA approved and capable of tolerating hot water temperatures of approximately 100 degrees Celsius. The material may be metal (e.g., stainless steel) or plastic (e.g., polypropylene).

The coffee container 4 also has the handle so that the user can hold the brewing filter apparatus. Preferably, the handle should be constructed of a sturdy, insulating material so as to protect the user from the heat of the coffee container. To serve its intended purpose, the handle may be constructed of a suitable material such as polypropylene plastic.

The foam maker 6 is affixed to the coffee container 4 from below and may be affixed to the coffee container 4 by a screw fit, whereby the exterior of said foam maker comprises threads and said coffee container comprises an orifice with corresponding grooves for receiving said threads. The foam maker may also be affixed to the coffee container by spot welding. The foam maker may be constructed of a suitable material such as plastic, metal, or a combination thereof. In one embodiment, the plastic is polypropylene and the metal is stainless steel. In a preferred embodiment, the plastic is glass-filled nylon and the metal is brass. The O-ring 5 is placed between the foam maker 6 and the coffee container 4 so as to form a seal.

In a preferred embodiment, the foam maker 6 has two opposing holes 7 extending from its exterior to its interior. The size of the holes ranges from 0.3 to 1 mm in diameter. During operation, the holes allow a horizontal jet of coffee to race into the interior of the foam maker, thereby turbulently contacting the other opposing jet of coffee and creating foam, froth, or crema. To facilitate agitation of the coffee and thus the formation of crema, a mesh 2, preferably made of stainless steel wire, is situated in the center of the foam maker 6 directly in the path of and between the opposing jets of coffee. Preferably, the mesh has in the range of 50 to 100 eyes per cm². The mesh provides a larger surface area for the contacting of the opposing coffee jets, resulting in greater turbulence of the coffee and the formation of more crema.

The brewing filter apparatus may be adapted or modified for use on various single-serve coffee machines. This is possible because the sealing component is located on the coffee machine. To begin, the user need just place the coffee grounds or coffee pod into the filter which is situated above the coffee container. A mesh cover may optionally be used to cover the coffee grounds, but such is unnecessary when using a coffee pod. The user may then insert the brewing filter apparatus into the coffee machine. During operation, the crema coffee or other brewed beverage will then flow from the brewing filter apparatus to the spout of the coffee maker and then to the user's cup.

The operation of this apparatus is relatively easy and straightforward. First, the user puts the proper amount of coffee grounds in the filter which sits on top of the coffee container of the apparatus. A mesh cover, which is optional and distinguished from the above-mentioned filter, may be placed on top of the coffee grounds to ensure that the grounds remain on the filter. A coffee pod may also be used with the apparatus such that a mesh cover is unnecessary. In such an instance, the coffee pod can be placed directly in the coffee container. The brewing filter apparatus is then placed on a coffee-making machine and secured. The present invention is now ready for brewing crema coffee.

Although, the preferred embodiment of the present invention is directed to making crema coffee, it should be understood that the brewing filter apparatus can be used to brew beverages and concoctions including, but not limited to, tea, liquid extracts, and the like.

What is claimed is:

1. A brewing filter apparatus comprising a filter, a coffee container, an O-ring, and a foam maker having a plurality of holes, whereby said filter is affixed to said coffee container from above, said foam maker is affixed to said coffee container from below, and the affixation of said foam maker and coffee container is sealed by said O-ring.

2. The brewing filter apparatus of claim 1, wherein the filter is affixed to the coffee container by press fitting, welding, or brazing.

3. The brewing filter apparatus of claim 1, wherein the filter is made of suitable metal.

4. The brewing filter apparatus of claim 3, wherein the metal is stainless steel.

5. The brewing filter apparatus of claim 1, wherein the coffee container is made of suitable metal or plastic.

6. The brewing filter apparatus of claim 1, wherein the O-ring is made of an elastomer.

7. The brewing filter apparatus of claim 6, wherein the elastomer is silicone rubber.

8. The brewing filter apparatus of claim 1, wherein the foam maker is affixed to the coffee container by screw fit or spot welding, whereby the exterior of said foam maker comprises threads and said coffee container comprises an orifice with corresponding grooves for receiving said threads.

9. The brewing filter apparatus of claim 1, wherein the foam maker is made of suitable metal or plastic.

10. The brewing filter apparatus of claim 9, wherein the metal is brass.

11. The brewing filter apparatus of claim 9, wherein the plastic is glass-filled nylon.

12. The brewing filter apparatus according to claim 1, wherein the foam maker comprises two holes.

13. The brewing filter apparatus according to claim 12, wherein the holes directly oppose each other.

14. The foam maker of claim 1, wherein the diameter of the holes ranges from 0.3 to 1 mm.

15. The brewing filter apparatus of claim 1, wherein the foam maker further comprises a mesh situated in the center of the foam maker, facing the plurality of holes.

16. The brewing filter apparatus of claim 15, wherein the mesh has in the range of 50 to 100 eyes per cm².

17. The brewing filter apparatus of claim 15, wherein the mesh is made of stainless steel wire.

18. A method of preparing foam, froth, or crema, comprising the steps of contacting two opposing jets of brewed liquid at a pressure less than 15 bar.

19. The method of claim 18, wherein the two opposing jets of brewed liquid are contacted at a pressure in the range of 1-3 bar.

20. The method of claim 18, further comprising situating a mesh between the opposing jets to facilitate the formation of foam, froth, or crema.
